(19) United States
(12) Patent Application Publication
(10) Pub. No.: US 2006/0198997 A1
(43) Pub. Date: Sep. 7, 2006

(54) Crosslinkable hot-melt adhesive mixture

(76) Inventors: Bernhard Goossens, Weeze (DE); Holger Jahn, Krefeld (DE); Ingo Notz, Krefeld (DE)

Correspondence Address: PERMAN & GREEN, 425 POST ROAD, FAIRFIELD, CT, 06824, US

(21) Appl. No.: 11/351,883

(22) Filed: Feb. 10, 2006

(30) Foreign Application Priority Data
Feb. 10, 2005 (DE) 10 2005 006 335.7
Aug. 29, 2005 (DE) 10 2005 040 979.2

(51) Int. Cl. B32B 3/26; C08L 77/00

(52) U.S. Cl. 428/304.4; 525/178

(57) ABSTRACT

A crosslinkable hot-melt adhesive for coating and/or laminating sheeting materials is described, whereby the hot-melt adhesive is an amino-terminated copolyamide and the crosslinking agent belongs to the chemical class of multifunctional acrylic acid esters and/or multifunctional acrylamides.

### CROSS-REFERENCE TO RELATED APPLICATIONS

This application claims priority from German Patent Application No. DE 10 2005 006 335.7 filed on Feb. 10, 2005, U.S. patent application Ser. No. 11/127,050 filed on May 11, 2005 and German Patent Application No. DE 10 2005 040 979.2 filed on Aug. 29, 2005.

### BACKGROUND OF THE INVENTION

1. Field of the Invention

The present invention relates to a crosslinkable hot-melt adhesive mixture for coating textile sheeting, e.g., textiles, leather, foams or plastics. The present invention relates in particular to a hot-melt adhesive mixture for coating thermosetting lining materials for the clothing industry.

2. Description of Related Art

It is known in the state of the art that hot-melt adhesive compounds can be used for solvent-free coating (hot-melt application, powder-point method) or for grid-type coating of aqueous hot-melt adhesive dispersions (paste-point or double-point method) for bonding solid or flexible substrates, in particular textile sheeting.

In printing technology, the powder-point method is a gravure printing method. The fabric liner sheeting is usually heated by wrapping it around a steel roller heated to approximately 170-220° C. and then pressed together with the sheeting against a hot printing roller at 30° to 60° C., containing the thermoplastic adhesive powder in its point-shaped recesses. The powder itself is applied to the recesses by using a funnel applicator. The printing roller (gravure roller, point roller, multiple-well roller) then presses the powder that is in the recesses onto the hot fabric liner sheeting. Therefore, superficial melting and agglomeration of the powder are achieved, so all the powder is removed from the recesses. Due to this agglomeration and/or downstream irradiation with height-adjustable infrared lamps, the powder grains of each point-shaped powder cluster are sintered together in a vitreous mass and are thus simultaneously anchored securely on the liner sheeting. In addition, the infrared lamps ensure the development of a smooth hemispherical surface of the adhesive points.

In the paste-point method, an aqueous dispersion of finely divided thermoplastic adhesive powders and additives, i.e., the paste, is usually pressed through the holes of a rotating perforated cylinder, i.e., the stencil, onto a cold product sheeting. The aqueous adhesive dispersion is pumped through a hollow doctor into the interior of the rotating stencil. By varying the paste viscosities, stencils with grids ranging from coarse to extremely fine can be used. The doctor blade of the adjustable hollow doctor that is mounted on the inside forces the paste through the holes in the stencil onto the product sheeting which runs over a mating roller that is hard or coated with soft rubber. Then the paste points are dried and subsequently sintered onto the textile product sheeting by circulating air and infrared lamps.

In the double-point method, a double point usually consists of a highly viscous or crosslinked lower point and a low-viscosity upper point. The lower point is applied by the rotary screen-printing process. While this lower point is still wet, an adhesive powder is scattered on it, but it adheres only to the wet paste point. The upper point powder that has fallen between the lower points is then removed with suction. In a drying channel, the water is removed from the lower point. It is sintered onto the lining substrate and the two points are then bonded together. The lower point should form a highly viscous barrier layer to prevent bleed-through back into the lining. The hot-melt adhesive of the upper point is then forced to run in the direction of the outer layer of material.

Traditional laminates produced with commercially available hot-melt adhesives based on copolyamides and/or copolyesters as well as their coating systems have the disadvantage that they retain their thermoplasticity after bonding. They are therefore subject to negative effects due to temperature, mechanical stress or exposure to solvents, which can result in delamination.

It is known in the state of the art that the thermoplasticity and solubility of the adhesive bonds of hot-melt adhesives can be reduced or eliminated by crosslinking. For example, isocyanate or silane crosslinking agents react with moisture to form three-dimensional non-fusible (thermoset plastic) polymers. However, using such crosslinking agents has the disadvantage that the systems must be stored in the absence of moisture until they are processed.

Hydroxy-functional or amino-functional hot-melt adhesives can also be crosslinked with blocked isocyanates. However, these crosslinking agents have the disadvantage that the deblocking temperature is usually above 140° C., so that comparatively high temperatures are required in reaction times that are of relevance for practical use, but these high temperatures prevent the use of temperature-sensitive substrates.

The advantages and disadvantages of the hot-melt adhesives modified in this way have been described in the literature and those skilled in the art are aware of them.

For application of the hot-melt adhesive, European Patent EP-A 598 873 discloses layered extrusion of a mixture of hydroxy-terminated or amino-terminated hot-melt adhesives with surface-deactivated isocyanate that. However, this substance mixture cannot be used as a powder base in the particle size of 1-80 μm, which is required for a grid-type printing, in aqueous dispersions, because the isocyanate is completely deactivated by water. Moreover, this method of production requires expensive extrusion systems.

European Patent EP-A 1 197 541 describes the use of micro-encapsulated polyisocyanate dispersions in combination with amino-terminated copolyamides or copolyesters to form an effective non-return barrier based on aqueous dispersions. However, preparation of such microencapsulated polyisocyanate dispersions is both complicated and expensive.

One object of the present invention has been to make available hot-melt adhesive systems which have advantages in comparison with the state-of-the-art systems. For application by a powder-point method, the hot-melt adhesive systems should, if possible, supply a crosslinking adhesive compound which retains its latent reactivity in surface sintering which is customary during production and which undergoes complete crosslinking only on reaching the final lamination temperature. Furthermore, when applied by the paste-point method, the hot-melt adhesive systems should, if possible, be suitable for application as aqueous dispersions to the respective substrate, should retain their latent reactivity when drying the applied points under the usual drying conditions and should be irreversibly crosslinkable only subsequently, when there is a further increase in temperature (final lamination, bonding). Finally, the hot-melt adhesive systems should build up an effective non-return barrier in application by the double-point method while also resulting in crosslinking in the final lamination and ensuring an improved wash-fastness and improved solvent resistance together with a reduced or eliminated thermoplasticity in particular in comparison with uncrosslinked hot-melt adhesive systems according to the state of the art.

This object is achieved by the subject of the patent claims.

### SUMMARY OF THE INVENTION

It has surprisingly been found that in application of the adhesive by the powder-point process, amino-terminated (co)polyamides, hydroxy-terminated (co)polyesters and/or amino-terminated (co)polyesters in combination with multifunctional acrylamide crosslinking agents, e.g., triacrylamido-trihydrotriazine (TATHT) yield a crosslinking adhesive compound when used as hot-melt adhesives in the melting range of 90° C. to 150° C., said adhesive compounds retaining their latent reactivity in surface sintering which is conventionally performed in production if the time-dependent temperature treatment on the powder point has been selected accordingly and the lamination temperature is above the melting point of the hot-melt adhesive. Only on reaching the final lamination temperature, e.g., greater than or equal to 130° C., does almost complete crosslinking occur.

Furthermore, it has surprisingly been found that in application by the paste-point method, amino-terminated (co)polyamides, hydroxy-terminated (co)polyesters and/or amino-terminated (co)polyesters in combination with multi-functional acrylamide crosslinking agents, e.g., triacryl-amido-trihydrotriazine (TATHT) or multifunctional acrylic acid ester crosslinking agents, e.g., trimethylolpropane triacrylate or triacrylic acid esters from ethoxylated trimethylolpropane will not react together spontaneously in an aqueous dispersion, optionally with the addition of acid, and even at elevated temperatures (e.g., 110° C.), addition still does not usually take place within the period of time conventionally used for industrial drying of a printed aqueous paste. Quantitative addition (=crosslinking) takes place only at higher lamination temperatures, e.g., greater than or equal to 130° C. 1

Furthermore, it has surprisingly been found that in application by the double-point method, amino-terminated (co)polyamides, hydroxy-terminated (co)polyesters and/or amino-terminated (co)polyesters in combination with multifunctional acrylic acid esters, e.g., ethoxylated trimethylolpropane triacrylate, can be applied as aqueous dispersions, whereby they create effective non-return barriers during drying through selective crosslinking (lower point). Treating the lower points formed in this way with powder mixtures of amino-terminated (co)polyamides, hydroxy-terminated (co)polyesters and/or amino-terminated (co)poly-esters in combination with multifunctional acrylamides, e.g., triacrylamido-trihydrotriazine (TATHT) (upper point) also yields an adhesive system that is crosslinked only on reaching the final lamination temperature, e.g., greater than or equal 130° C.

### DETAILED DESCRIPTION OF THE INVENTION

The present invention relates to a crosslinkable hot-melt adhesive mixture comprising
a hot-melt adhesive component which comprises at least
   an amino-terminated (co)polyamide and/or
   a a hydroxy-terminated (co)polyester and/or
   a an amino-terminated (co)polyester, and
a crosslinking component which comprises at least one multifunctional acrylate ester and/or at least one multifunctional acrylamide.

In the preferred embodiment, the present invention relates to a powdered crosslinkable hot-melt adhesive mixture comprising an amino-terminated (co)polyamide, a hydroxy-terminated (co)polyester and/or an amino-terminated (co)polyester and a crosslinking agent from the chemical class of trifunctional acrylamides. The powdered crosslinkable hot-melt adhesive mixture is preferably used according to this invention as a coating material according to powder-point method (or it is used to form the upper points in the double-point method, see below). In this embodiment, the present invention also relates to a method for coating substrates with the help of the inventive powdered crosslinkable hot-melt adhesive mixture.

In another preferred embodiment, the present invention relates to a crosslinkable hot-melt adhesive mixture based on an aqueous paste comprising an amino-terminated (co)polyamide, a hydroxy-terminated (co)polyester and/or an amino-terminated (co)polyester and a crosslinking agent from the chemical class of trifunctional acrylamides or trifunctional acrylate esters. The crosslinkable hot-melt adhesive mixture based on a paste is preferred according to this invention for a grid pattern coating, e.g., of thermosetting lining materials for the clothing industry, applied by the paste-point method. In this embodiment, the present invention also relates to a method for coating substrates with the help of the inventive hot-melt adhesive mixture based on the aqueous paste.

In another preferred embodiment, the present invention relates to a crosslinkable hot-melt adhesive coating based on an aqueous dispersion, comprising an amino-terminated (co)polyamide, a hydroxy-terminated (co)polyester and/or an amino-terminated (co)polyester and a crosslinking agent from the chemical class of trifunctional acrylate esters. The crosslinkable hot-melt adhesive mixture based on an aqueous dispersion is preferably used according to this invention for a grid type coating, e.g., of thermosetting lining materials for the clothing industry by the double-point method, preferably to form crosslinkable lower points during drying. The present invention also provides a powdered hot-melt adhesive or a mixture of a hot-melt adhesive and a crosslinking agent (upper point)for applying powder to the lower points. The present invention in particular provides a powdered crosslinkable hot-melt adhesive mixture which comprises an amino-terminated (co)polyamide, a hydroxy-terminated (co)polyester and/or an amino-terminated (co)polyester in combination with a crosslinking agent from the chemical class of trifunctional acrylamides and which is used according to this invention preferably as a powdered material for the upper point in the double-point method and as a coating material according to the powder-point method. In this embodiment, the invention also relates to a method for coating substrates with the help of the inventive hot-melt adhesive mixture based on an aqueous dispersion (lower point) with the help of the powdered crosslinkable hot-melt adhesive (upper point).

In a preferred embodiment of the inventive hot-melt adhesive mixture, the relative weight ratio of the hot-melt adhesive component to the crosslinking component is in the range of 99.9:0.1 to 50:50, preferably 98:2 to 60:40, or even more preferably from 97:3 to 70:30 and most preferably from 95:5 to 80:20.

In a preferred embodiment, the hot-melt adhesive combination includes at least one amino-terminated (co)polyamide. For the purpose of the present description, the term “(co)polyamide” includes both (co)polyamides and polyamides.

The inventive hot-melt adhesive component preferably comprises an amino-terminated (co)polyamide having a melting range within 85-150° C., preferably 85-135° C., more preferably 90-130° C., more preferably 90-130° C., even more preferably from 95-125° C. and most preferably from 100-120° C. Those skilled in the art will be familiar with suitable methods of determining the melting range of a (co)polyamide. The melting range is preferably determined according to DIN 53736 or with the help of a Kofler heating bench.

The amino-terminated (co)polyamide preferably has a melt flow index (MFI) in the range of 5 to 100 g/10 min, preferably from 6 to 40 g/10 min, more preferably in the range from 7 to 30 g/10 min and especially from 8 to 20 g/10 min, determined according to DIN EN ISO 1133 at 140° C. and 2.16 kg.

The amino-terminated (co)polyamide preferably has 100-800 meq amino groups per kg polyamide, preferably 150-750 meq amino groups per kg polyamide, even more preferably 200-700 meq amino groups per kg polyamide, most preferably 250-650 meq amino groups per kg polyamide and especially 300-600 meq amino groups per kg polyamide.

The amino-terminated (co)polyamide preferably has an intrinsic viscosity [0] of 1.0 to 2.0 mpas, more preferably 1.1 to 1.9 mpas, even more preferably 1.2 to 1.8 mPas and especially preferably from 1.3 to 1.7 mpas, preferably determined according to DIN 51562-3.

The amino-terminated (co)polyamide (PA) is preferably based on a polymer selected from the group consisting of PA 4, PA 5, PA 6, PA 7, PA 8, PA 9, PA 10, PA 11, PA 12, PA 4.2, PA 6.6, PA 6.8, PA 6.9, PA 6.10, PA 6.12, PA 7.7, PA 8.8, PA 9.9, PA 10.9, PA 12.12, PA 6/6.6, PA 6.6/6, PA 6.2/6.2, PA 6.6/6.9/6, PA 12/6-6/6, PA 12/12-6/6, PA 6/6-6/12-6, PA 11/6-6/6, PA 11/6-12/6, PA 12/11/6-6/6, PA 12/6-6/6-12/6 and PA 12/6-6/6-10/6. Suitable (co)polyamides are commercially available.

The (co)polyamide is amino-terminated. In the sense of the description, this means that preferably at least 90 mol%, preferably at least 95 mol% of the terminal groups of the (co)polyamide are amino groups. An example of a preferred amino-terminated polyamide is a compound of general formula (1): 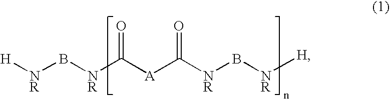
where
A and B may be the same or different and are selected from the group consisting of C₁-C₈-alkylene and C₀-C₈-alkylene-phenylene-C₀-C₈-alkylene, optionally substituted with one or two moieties selected from F, Cl, C₁-C₈-alkyl and O—C₁-C8-alkyl;
R stands for H or C₁-C₈-alkyl, preferably H; and
n is an integer, preferably in the range of 100 to 100,000.
“C₁-C₈ alkylene” in the sense of this description denotes a linear or branched alkylene group with 1 to 8 carbon atoms, e.g., CH₂CH₂, CH₂CH₂CH₂ or CH(CH₃)CH₂.

“C₁-C₈ alkyl” in the sense of this description denotes a linear or branched alkyl group with 1 to 8 carbon atoms, e.g., CH₃, CH₂CH₃ or CH(CH₃)₂.

“C₁-C₈ alkylene-phenylene-C₀-C₈-alkylene” in the sense of this description denotes an otho-, meta- or para-phenylene group which is optionally substituted in 1,2, 1,3 or 1,4-position with one or two alkylene groups, e.g., C₆H₄, CH₂₋C₆H₄ or CH₂-C₆H₄₋CH₂.

In another preferred embodiment, the hot-melt adhesive component includes at least one hydroxy-terminated (co)polyester. For the purpose of this description the term “(co)polyester” includes both copolyesters and polyesters.

The hydroxy-terminated (co)polyester is preferably a copolyester whose main components are based on aliphatic and/or aromatic dicarboxylic acids and aliphatic and/or aromatic diols and/or triols. Preferred aromatics dicarboxylic acids include terephthalic acid and isophthalic acid. Preferred aliphatic dicarboxylic acids include glutaric acid and adipic acid. Preferred aliphatic diols and triols include butanediol, diethylene glycol and triethylene glycol. In a preferred embodiment, the hydroxy-terminated (co)-polyester is based on a polymer selected from the group consisting of polycarbonate, polyethylene terephthalate (PET), polybutylene terephthalate (PBT) and polyhydroxy alkanoate (e.g., polyhydroxy butyrate (PHB)). Suitable (co)polyesters are commercially available.

These (co)polyesters are hydroxy-terminated. In the sense of the description, this means that preferably at least 90 mol%, especially at least 95 mol% of the terminal groups of the (co)polyester are hydroxyl groups. An example of a preferred hydroxy-terminated polyester is a compound of general formula (2): 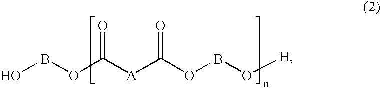
where
A, B and n are defined as indicated above in conjunction with general formula (1).

In another preferred embodiment, the hot-melt adhesive component includes at least one amino-terminated (co)polyester which is defined with regard to its chemical structure preferably like the hydroxy-terminated (co)polyester described above but in contrast with that is characterized in that preferably at least 90 mol%, especially at least 95 mol% of the terminal groups of the (co)polyester are amino groups. Those skilled in the art will be aware of suitable amino-terminated (co)polyesters processes for synthesis of same.

The amino-terminated (co)polyester preferably has 100-800 meq amino groups per kg polyester, preferably 150-750 meq amino groups per kg polyester, even more preferably 200-700 meq amino groups per kg polyester, most preferably 250-650 meq amino groups per kg polyester and especially 300-600 meq amino groups per kg polyester.

One example of a preferred amino-terminated polyester is a compound of general formula (3) 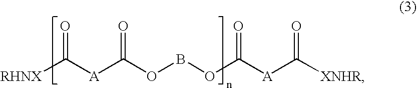
where
A, B, n and R have the meanings defined above in conjunction with general formulas (2) and (3) and XNHR is selected from the group consisting of NHR, NH—C₁-C₈-alkylene-NHR or NH—C₀-C₈-alkylene-phenylene-C₀-C₈-alkylene-NHR.

The crosslinking component of the inventive hot-melt adhesive mixture includes at least one multifunctional acrylate ester and/or at least one multifunctional acrylamide. The term “acryl” in the sense of the description also includes derivatives of acrylic acid which are optionally substituted with alkyl groups, e.g., including derivatives of methacrylic acid.

In a preferred embodiment, the crosslinking component includes a multifunctional acrylate ester and/or a multifunctional acrylamide with more than two reactive groups per molecule. In the sense of this description, the term “reactive group” in conjunction with the multifunctional acrylic acid ester and/or the multifunctional acrylamide refers to a functional group which is suitable for reacting with a complementary functional group of a component of the hot-melt adhesive component, so that the crosslinking effect of the crosslinking component is manifested. The reactive group is preferably an olefinic double bond which may be attacked by a nucleophilic group, optionally at an elevated temperature.

In a preferred embodiment, the crosslinking component includes a multifunctional acrylic acid ester and/or a multifunctional acrylamide with more than two reactive double bonds per molecule. In the sense of this description, the term “activated double bond” in conjunction with the multifunctional acrylic acid ester and/or the multifunctional acrylamide refers to an olefinic double bond whose reactivity in a nucleophilic addition reaction is increased in comparison with an ordinary olefin (alkene). The activation may be achieved in particular by an electron-attracting substituent. One example of an activated double bond is the Michael system (α, β-unsaturated carbonyl) which is derived from acrylic acid esters or acrylic acid amides. It can be derived from acrylic acid esters or acrylic acid amides. This substance may undergo nucleophilic attack at an elevated temperature by the terminal amino groups and the amide groups of the amino-terminated (co)polyamide that still have hydrogen atoms or by the terminal amino groups of the amino-terminated (co)polyester and/or by the terminal hydroxyl groups of the hydroxy-terminated (co)polyester, resulting in crosslinking of the hot-melt adhesive component by the crosslinking component.

A multifunctional acrylic acid ester in the sense of this description is preferably a molecule having at least two functional groups of general formula (I) 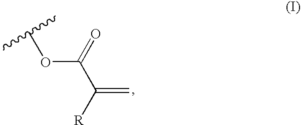
where R denotes H or C₁-C₈-alkyl independently of one another.

The multifunctional acrylic acid ester preferably has two, three or four functional groups of general formula (I), where R is preferably CH₃ or H.

A multifunctional acrylamide in the sense of this description is preferably a molecule having at least two functional groups of general formula (II) 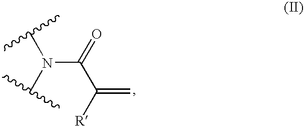
where R′ denotes H or C₁-C₈-alkyl independently of one another.

The multifunctional acrylamide preferably has two, three or four functional groups of general formula (II) where R′ is preferably CH₃ or H.

In a preferred embodiment the crosslinking component preferably includes a trifunctional acrylamide of general formula (III) 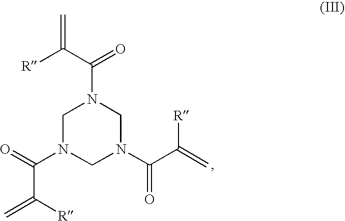
where R″ denotes H or C₁-C₈-alkyl, preferably H or CH₃, independently of one another.

A preferred trifunctional acrylamide of general formula (III) as the crosslinking component is triacrylamido-trihydrotriazine (1,3,5-triacryloyl-hexahydro-1,3,5-triazine, TATHT).

In another preferred embodiment, the crosslinking component comprises a trifunctional acrylic acid ester selected from the group consisting of glycerol tri(meth)acrylate, glycerol ethoxylate-tri(meth)acrylate, glycerol propoxylate-tri(meth)-acrylate, pentaerythritol-tri(meth)acrylate, pentaerythritol-ethoxylate-tri(meth)acrylate and trimethylolpropane propoxylate tri(meth)acrylate.

In the sense of this description, the term “(meth)acrylate” includes both acrylate and methacrylate.

In this embodiment, the inventive hot-melt adhesive mixture is suitable in particular for use in the double-point method, where a mixture of an amino-terminated (co)polyamide, a hydroxy-terminated polyester and/or an amino-terminated (co)polyester can be applied as the hot-melt adhesive component in combination with the multifunctional acrylic acid ester as the crosslinking component, preferably ethoxylated trimethylolpropane triacrylate, as aqueous dispersions to form the lower point. In this embodiment, the upper point may consist of hot-melt adhesive mixtures that advantageously contain a multifunctional acrylamide, e.g., triacrylamido-trihydrotriazine (TATHT) as the crosslinking component in addition to an amino-terminated (co)polyamide, a hydroxy-terminated (co)polyester and/or an amino-terminated (co)polyester as the hot-melt adhesive component.

One aspect of the present invention thus relates to a hot-melt adhesive system which is suitable for use in the double-point process, e.g., for coating liner materials in a grid-type pattern for the clothing industry. The inventive hot-melt adhesive system includes a crosslinkable hot-melt adhesive mixture based on an aqueous dispersion comprising an amino-terminated (co)polyamide, a hydroxy-terminated (co)-polyester and/or an amino-terminated (co)polyester in combination with a crosslinking agent from the chemical class of trifunctional acrylic acid esters, whereby the lower point is formed from this hot-melt adhesive mixture and undergoes crosslinking during drying. Furthermore, the inventive hot-melt adhesive system includes a powdered hot-melt adhesive or a powdered mixture of a hot-melt adhesive component and a crosslinking component, whereby the lower point is treated so that the upper point is formed and then the latter can also undergo crosslinking in the subsequent lamination process. The inventive hot-melt adhesive system preferably includes a powdered hot-melt adhesive mixture consisting of an amino-terminated (co)polyamide, a hydroxy-terminated (co)polyester and/or and amino-terminated (co)polyester in combination with a crosslinking agent from the chemical class of trifunctional acrylamides as the powder material.

In a preferred embodiment, the inventive hot-melt adhesive mixture does not contain any isocyanates, optionally blocked isocyanates.

The inventive hot-melt adhesive mixture is preferably almost completely crosslinkable on heating to a temperature according to at least the melting point and/or at least the melting range of its hot-melt adhesive component and/or its crosslinking component. Almost complete crosslinking preferably takes place only at a temperature of at least 120° C., preferably at least 130° C. and even more preferably at least 140° C. Those skilled in the art are aware of suitable methods of determining the degree of crosslinking of polymers. In this connection, reference can be made to the full extent to, for example, M. Rubinstein et al., Polymer Physics, Oxford University Press (2003) and J. Mark et al., Physical Properties of Polymers, Cambridge University Press, 3rd edition (2004).

The inventive hot-melt adhesive mixture is preferably in the form of an aqueous composition, in particular a paste. The water content preferably amounts to at least one 1 wt%, more preferably at least 5 wt%, even more preferably at least 10 wt%, most preferably at least 25 wt% and especially 50 wt%, based on the total weight of the hot-melt adhesive mixture.

The inventive hot-melt adhesive mixture is preferably in the form of an aqueous dispersion, an aqueous paste or a powder.

If the inventive hot-melt adhesive mixture is in the form of a powder, then the powder preferably has an average particle size between 80 and 200 μm. In another preferred embodiment, the powder is in the form of finer grain fractions in the range of 1 to 120 μm, preferably 1 to 80 μm.

If the inventive hot-melt adhesive mixture is in the form of an aqueous paste, the amount by weight of the sum of the hot-melt adhesive component and the crosslinking component is preferably in the range of 25 wt% to 99 wt%, more preferably 35 wt% to 95 wt%, even more preferably 50 to 90 wt%, most preferably 60 wt% to 85 wt% and especially 65 wt% to 80 wt%, each based on the total weight of the hot-melt adhesive mixture.

If the invention hot-melt adhesive mixture is in the form of an aqueous dispersion, the amount by weight of the sum of the hot-melt adhesive component and the crosslinking component is preferably in the range of 1.0 to 99 wt%, more preferably 5.0 to 95 wt%, even more preferably 7.5 to 75 wt%, most preferably 10 to 60 wt% and especially 15 to 50 wt%, each based on the total weight of the hot-melt adhesive mixture.

The inventive hot-melt adhesive mixture preferably contains one or more of the following additives to improve its properties:
thickeners,
dispersants,
plasticizers,
wetting agents,
lubricants/flow improvers and/or
organic acids.

Those skilled in the art will be familiar with suitable additives to improve properties. In this connection, reference can be made to the full extent to G. Wypych, Handbook of Plasticizers, Noyes Publications (2003); S. Al-Malaika et al., Specialty Polymer Additives: Principles and Applications, Blackwell Publishing, Inc. (2002); J. C. J. Bart, Additives in Polymers: Industrial Analysis and Applications, John Wiley & Sons, Ltd. (2005); German Patents DE-A 20 07 971; DE-A 22 29 308; DE-A 24 07 505; and DE-A 25 07 504.

In a preferred embodiment, the inventive hot-melt adhesive mixture contains an acid, preferably an organic acid. It has been found that when certain hot-melt adhesive components are brought together with certain crosslinking components, depending on the chemical composition, a spontaneous crosslinking may take place which may be either desired (lower point) or undesired (paste-point). For example, the reaction of ethoxylated trimethylolpropane triacrylates (water soluble) with amino-terminated copolyamides (usually not water soluble, but swellable in water) in aqueous formulations (e.g., in printing pastes) takes place relatively rapidly at room temperature, which may result in spontaneous crosslinking. However, it has been found that this spontaneous crosslinking reaction can be controlled by adding suitable acids, preferably organic acids, especially aliphatic carboxylic acids. Examples of suitable acids include formic acid, acetic acid, propionic acid, oxalic acid, malonic acid, glutaric acid, fumaric acid, maleic acid, citric acid, benzoic acid, phenyl acetic acid, benzenesulfonic acid, p-toluenesulfonic acid, etc.

It has been found that protonation of the amino groups of the amino-terminated (co)polyesters and the associated loss of nucleophilic properties are sufficient to suppress spontaneous crosslinking without also preventing lamination at elevated temperatures (e.g., 140° C.) in the melt. Especially when using the inventive hot-melt adhesive mixture in the paste-point process, it is therefore preferable to add suitable acids.

The inventive hot-melt adhesive mixture is characterized in that it ensures excellent primary adhesion between two substrates to be bonded, in particular textile substrates. The primary adhesion to cotton or viscose is preferably at least 14 N/5 cm, more preferably at least 16 N/5 cm, even more preferably at least 18 N/5 cm, most preferably at least 20 N/5 cm and especially at least 22 N/5 cm.

The adhesion between two textile substrates bonded together with the help of the inventive hot-melt adhesive mixture preferably undergoes little or no change when the laminate is subjected to a washing at 60° C., preferably according to ISO 4319, ASTM D 2960-84 and DIN 44983 and/or to dry cleaning, preferably according to ISO 4319, ASTM D 2960-84 and/or DIN 44983. Based on the primary adhesion, the reduction in adhesion after washing at 60° C. and/or after dry cleaning is preferably reduced by max. 20%, more preferably by max. 15%, even more preferably by max. 10%, most preferably by max. 5% and especially by max. 2%.

According to another aspect of the present invention, the crosslinkable hot-melt adhesive mixture described above is used as a hot-melt adhesive, preferably for textile substrates. The hot-melt adhesive mixture is preferably used for the powder-point process, the paste-point process or the double-point process. If it is used for the double-point process, the hot-melt adhesive mixture is preferably used to create the upper point and/or lower point.

Another aspect of the present invention relates to a method for coating substrates, preferably textile sheeting, comprising the step
Applying a crosslinkable hot-melt adhesive mixture as described above to the substrate, whereby the hot-melt adhesive component and the crosslinking component are applied simultaneously or one after the other.

In a preferred embodiment of the inventive method, the adhesive is applied by the powder-point method, by the paste-point method or by the double-point method.

If the adhesive is applied by the double-point method, the inventive crosslinkable hot-melt adhesive mixture is preferably applied as a lower point and/or as an upper point.

Another aspect of the present invention relates to a method for laminating substrates, comprising the steps
(a) coating at least one first substrate, preferably a textile sheeting, with a crosslinkable hot-melt adhesive mixture as described above and
(b) laminating the substrate obtained according to step (a) with at least one additional substrate at a temperature which is at least high enough that almost complete crosslinking of the hot-melt mixture occurs.

In a preferred embodiment of the inventive lamination method, the temperature in step (b) corresponds at least to the melting point and/or the melting range of the hot-melt adhesive component and/or the crosslinking component, preferably the hot-melt adhesive component.

Another aspect of the present invention relates to a substrate, preferably a textile sheeting, which is coated with a crosslinkable hot-melt adhesive as described above.

The present invention is explained in greater detail below on the basis of examples. These examples are used only to illustrate the present invention and are not to be interpreted as restrictive with regard to the scope of the invention.

### EXAMPLE 1A (PASTE-POINT METHOD)

An amino-terminated copolyamide (e.g., 1-80 μm, melting range 85-135° C., melt viscosity 10-100 g/10 min at 140° C., 100-800 meq amine/kg) and TATHT (triacrylamido-trihydrotriazine) were processed to yield a printable paste using conventional commercial dispersants and thickeners as well as organic acids, e.g., as described in DE-B 20 07 971, DE-B 22 29 308, DE-B 24 07 505 and DE-B 25 07 504 and then printed using conventional commercial rotary printing stencils on a nonwoven (PET/PA blend having a weight of approximately 25 g/m²) with a dry application of 7-12 g/m².

After drying at 110° C. and storing the printed nonwoven for one week at room temperature, it was sealed against an acetate outer fabric sheeting at 140° C. (15 sec, 4 N/cm²) and the laminate was subjected to washing at 60° C. and dry cleaning. Then the adhesion of the laminate was determined.

Result:

Primary adhesion: pull-away of the nonwoven

60° C. washing: pull-away of the nonwoven

Dry cleaning: pull-away of the nonwoven

### EXAMPLE 1b

In the recipe according to Example 1a, the crosslinking agent TATHT was replaced by the triacrylic acid ester of ethoxylated trimethylolpropane. After applying pressure and drying at 110° C. and storing for one week at room temperature, the printed nonwoven was sealed against an acetate outer fabric at 140° C. (15 sec, 4 N/cm2 ) and the thermal stability of the laminate was tested at 150° C.

Result:

The laminate remained stable under a weight load and did not delaminate.

### Comparative Example 1

The corresponding recipe according to Example 1 but without the crosslinking agent TATHT and/or trimethylolpropane (EO)_{X} triacrylate yielded the following results after thermosetting under identical conditions:

Primary adhesion: pull-away of nonwoven

Washing at 60° C.: delamination

Dry cleaning: delamination

Thermal stability at 150° C.: delamination

### EXAMPLE 2 (DOUBLE-POINT METHOD)

An amino-terminated copolyamide according to Example 1 was processed as described in Example 1 using conventional dispersants and thickening agents and with the addition of ethoxylated trimethylolpropane triacrylate to yield a printable paste and used for printing a relatively open HB-textured polyester knit (weight 33 g/m²) using a rotary screen printing machine with a CP 66 stencil, for example. While still wet the paste-point (application dry 3 g/m², lower point according to the invention) was treated by dusting with a) pure amino-terminated copolyamide—comparative upper point, b) with a powder mixture of amino-terminated copolyamide and TATHT—the upper point according to this invention. After suction removal of the excess powder, this fabric was dried at 125° C. in passage through the dryer and partially sintered. The application of the upper point amounted to 6 g/m² each.

After storing for one week at room temperature, the coated knits were sealed against an acetate outer fabric at 140° C. (15 sec, 4 N/cm² ) and the laminate was subjected to washing at 60° C. and to dry cleaning.

A similar experiment was performed without crosslinking agent in the lower point. After that the adhesion of the laminated materials was determined.

The rear riveting was evaluated manually according to an evaluation scale of 1 (no adhesion to the test laminate) to 6 (full bleed-through).

Result:

Lower point without crosslinking agent/upper point without crosslinking agent:

Primary adhesion: 16 N/5 cm

Washing at 60° C.: 6 N/5 cm

Dry cleaning: delamination

Back riveting: 5

Lower point with inventive crosslinking agent/upper point without crosslinking agent:

Primary adhesion: 18 N/5 cm

Washing at 60° C.: 9 N/5 cm

Dry cleaning: 3.5 N/5 cm

Back riveting: 1

Lower point without crosslinking agent/upper point with crosslinking agent:

Primary adhesion: 18 N/5 cm

Washing at 60° C.: 17 N/5 cm

Dry cleaning: 14 N/5 cm

Back riveting: 4

Lower point with inventive crosslinking agent/upper point with inventive crosslinking agent:

Primary adhesion: 20 N/5 cm

Washing at 60° C.: 19 N/5 cm

Dry cleaning: 18 N/5 cm

Back riveting: 1

### EXAMPLE 3 (POWDER-POINT METHOD)

A powder mixture of amino-terminated copolyamide and TATHT was applied (application 10 g/m²) with a CP 66 gravure printing roller to a PET fabric (weight 45 g/m²) at 125° C., sintered at the surface and thermoset at 140° C. with a wool/polyester blend at a linear pressure of 4 N.

The laminate was subjected to washing at 60° C. and to dry cleaning. Then the adhesion values were determined.

Result:

Primary adhesion: 22 N/5 cm

Washing at 60° C.: 21 N/5 cm

Dry cleaning: 20 N/5 cm

A comparative test was performed without the admixture of a crosslinking agent:

Result without crosslinking agent:

Primary adhesion: 22 N/5 cm

Washing at 60° C.: 8 N/5 cm

Dry cleaning: 12 N/5 cm

1. A crosslinkable hot-melt adhesive mixture, comprising
a) a hot-melt adhesive component comprising at least one amino-terminated (co)polyamide and
b) a crosslinking component which contains at least one multifunctional acrylic acid ester and/or at least one multifunctional acrylamide.

2. The hot-melt adhesive mixture according to claim 1, wherein the hot-melt adhesive component comprises an amino-terminated (co)polyamide with a melting range of 90-150° C.

3. The hot-melt adhesive mixture according to claim 1, wherein the crosslinking component comprises a multifunctional acrylamide and/or a multifunctional acrylic acid ester with more than two reactive groups per molecule.

4. The hot-melt adhesive mixture according to claim 3, wherein the crosslinking component comprises a multi-functional acrylamide and/or a multifunctional acrylic acid ester with more than two activated double bonds per molecule.

5. The hot-melt adhesive mixture according to claim 1, wherein the crosslinking component comprises triacryl-amido-trihydrotriazine (TATHT) and/or ethoxylated tri-methylolpropane triacrylate.

6. The hot-melt adhesive mixture according to claim 1, which contains an organic acid.

7. The hot-melt adhesive mixture according to claim 6, wherein the organic acid is selected from the group consisting of formic acid, acetic acid, propionic acid, oxalic acid, malonic acid, glutaric acid, fumaric acid, maleic acid and citric acid.

8. The hot-melt adhesive mixture according to claim 1, which is in the form of an aqueous dispersion or a powder.

9. Multi-layered sheeting selected from textile, leather, foam and plastic sheeting, where the layers of the sheeting are adhered to one another by the a hot-melt adhesive mixture according to claim 1.

10. The multi-layered sheeting of claim 9 where the sheeting is textile sheeting.

11. The multi-layered sheeting of claim 9 where the hot-melt adhesive mixture is applied by one of the powder-point method, the paste-point method or the double-point method.

12. A method for coating substrates, comprising the step of applying a crosslinkable hot-melt adhesive mixture according to claim 1 to the substrate, whereby the hot-melt adhesive component and the crosslinking component are applied simultaneously or in succession.

13. The method according to claim 12, wherein the substrates are textile sheetings.

14. The method according to claim 12, wherein the application is performed by the powder-point method, the paste-point method or the double-point method.

15. The method according to claim 14, wherein the application is performed by the double-point method and the crosslinkable hot-melt adhesive mixture is applied as a lower point and/or as an upper point.

16. A method for laminating substrates, comprising the steps
(a) coating at least one first substrate with a crosslinkable hot-melt adhesive mixture according to claim 1; and
(b) laminating the substrate obtained according to step (a) with at least one additional substrate at a temperature which is at least high enough for almost complete crosslinking of the hot-melt adhesive to occur.

17. The method according to claim 16, wherein the substrates are textile sheetings.

18. The method according to claim 16, wherein the temperature in step (b) corresponds at least to the melting point and/or the melting range of the hot-melt adhesive component and/or the crosslinking component.

19. A substrate coated with a crosslinkable hot-melt adhesive mixture according to claim 1.

20. The substrate according to claim 19, which is a textile sheeting.
